(19) United States
(12) Patent Application Publication
(10) Pub. No.: US 2004/0003043 A1
(43) Pub. Date: Jan. 1, 2004

(54) Remote control of document objects in a collaborative environment

(75) Inventors: Ramakrishnan Rajamony, Austin, TX (US); Freeman Leigh Rawson III, Austin, TX (US)

Correspondence Address: Joseph P. Lally, DEWAN & LALLY, L.L.P., P.O. Box 684749, Austin, TX, 78768-4749, US

(73) Assignee: International Business Machines Corporation, Armonk, NY

(21) Appl. No.: 10/177,845

(22) Filed: Jun. 20, 2002

(51) Int. Cl. G06F 15/16

(52) U.S. Cl. 709/205

(57) ABSTRACT

A system and method in which two or more parties are enabled to use a ubiquitous application such as a web browser in conjunction with a specially configured server to facilitate collaborative efforts on a document. A browser loaded on a first data processing system accesses a specified web page located on a server that contains an applet tag which transfers an event applet to the first data processing system. A second browser operating on a second data processing system accesses the same web page and thereby transfers a copy of the event applet to the second system. In a symmetric implementation, both event applets are configured to monitor the browser for events. If an event is detected by one of the browsers, it communicates the detected event to a coordinating application residing on the server. When the coordinating application monitor receives an event message from one of the browsers, it communicates the event to the other browser via the event applet. The event applet on the other browser then replicates the event on its browser such that any event occurring on the first browser occurs on the second browser. The invention further contemplates a non-symmetric implementation in which specified browsers are designated as masters while others are designated as workers. In this implementation, events that occur on master browsers are reflected (duplicated) on the worker browsers, but not vice versa.

### BACKGROUND

1. Field of the Present Invention

The present invention generally relates to the field of data processing networks and more particularly to a system and method enabling collaborative manipulation of a document from remote locations using a ubiquitous application such as a conventional web browser.

2. History of Related Art

In collaborative and help-desk environments, a common requirement is the ability for two or more parties to view and make updates to the same document object. Existing attempts to provide this type of functionality generally require the parties, or a third-party provider, to install proprietary software that facilitates document manipulation. Such proprietary solutions, however, are typically costly and require the parties to accept or use software from a potentially unreliable source. The installed software, of course, would also consume valuable system resources on the parties' systems. Thus, it would be desirable to provide for multi-party document control without requiring either party to invest in or install any new software. It would be further desirable if the implemented solution addressed security issues by, for example, limiting the actions of any software used to achieve the collaboration. It would be still further desirable if the implemented solution leveraged, to the extent possible, existing programming languages, programming interfaces, and Internet standards to maximize the implementation's potential benefit.

### SUMMARY OF THE INVENTION

The problems identified above are in large part addressed by a system and method in which two or more parties are enabled to use a ubiquitous application such as a web browser in conjunction with a specially configured server to facilitate collaborative efforts on a document. In a typical implementation, a standard web browser serves as the ubiquitous application. A browser loaded on a first data processing system accesses a specified web page located on a server. The web page contains an applet tag that transfers an event applet to the first data processing system. Similarly, a second browser operating on a second data processing system accesses the same web page and thereby transfers a copy of the event applet to the second system. In a symmetric implementation, in which, either browser may initiate action that is mimicked by the other browser, the event applet is configured to monitor the browser for events. If an event is detected, the event applet is configured to communicate the detected event to a coordinating application residing on the server. When the coordinating application receives an event message from one of the browsers, it communicates the event to the other browser via the event applet. The event applet then replicates the event on its browser such that any event occurring on the first browser occurs on the second browser. The invention further contemplates a non-symmetric implementation in which specified browsers are designated as masters while others are designated as workers. In this implementation, events that occur on master browsers are reflected (duplicated) on the worker browsers, but not vice versa.

### BRIEF DESCRIPTION OF THE DRAWINGS

Other objects and advantages of the invention will become apparent upon reading the following detailed description and upon reference to the accompanying drawings in which:

FIG. 1 is a block diagram of selected features of a data processing network according to one embodiment of the present invention;

FIG. 2 is a block diagram illustrating selected features of a data processing network according to one embodiment of the present invention;

FIG. 3 is a block diagram illustrating selected features of an alternative embodiment of a data processing network according to the present invention;

FIG. 4 is a flow diagram illustrating a method of collaboratively modifying a document in a networked environment according to one embodiment of the present invention; and

FIG. 5 depicts pseudo code of selected software modules suitable for use in the network depicted in FIG. 2.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE INVENTION

Generally speaking the present invention contemplates a system and method that enable two or more users at remote locations to work collaboratively using only a ubiquitous application such as a conventional web browser. An image of a document such as a web page is provided to both users by their respective applications. Events that occur on one of the applications are then mirrored or replicated on the other. In this manner, the users can cooperatively work on a networked document.

Initially, the users invoke their respective applications to access a predetermined web page on a specified server. The web page includes an applet that is configured to monitor events that occur on the user's application. When the server web page is accessed, the applet is loaded into the user's system and executed by the application. The applet then monitors the user application for events such as mouse clicks, text entry, etc. The applet communicates any events it detects to a coordinating application executing on the server. In response to receiving an event message from one of the applets, the coordinating application is configured to inform the other user application (via its applet) of the event. The applet receiving the event information from the server application is configured to replicate the event within its user application. Because the applet executes within the user application and is able to communicate only with the server from which it originated, the system and method offer increased security to the users. In addition, the invention eliminates the cost of purchasing and installing proprietary collaboration software by leveraging an application that is resident on most systems.

Portions of the present invention may be implemented as a sequence of computer executable instructions (software) enabling two users to work collaboratively on a document via a data processing network such as a local area network or a wide area network including the Internet. When this is the case, the software is typically stored or encoded on a computer readable medium. During times when the software is being executed, it may reside on a volatile storage element such as the system memory (DRAM) of a data processing system or an internal or external cache (SRAM) of a processor in the data processing system. When the software is not being executed, the instructions may reside in a non-volatile storage element such as a hard disk, a floppy diskette, a flash memory card, EEPROM, CD ROM, DVD, magnetic tape, or other suitable medium.

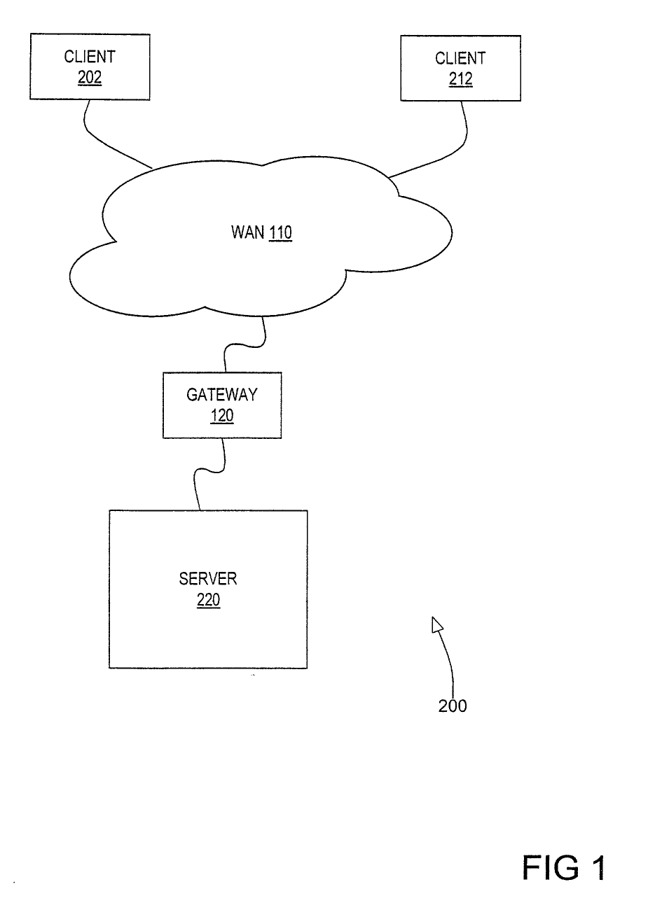

Before discussing the document collaboration elements of the present invention, selected elements of a network on which the invention might suitably be implemented are described. Referring to the drawings, FIG. 1 illustrates selected elements of a data processing network (system) 200. The depicted embodiment of system 200 includes a pair of client data processing systems 202 and 212 connected to a wide area network 110. Data processing systems 202 and 212 may be implemented as conventional desktop or laptop style personal computers, network computers, personal data administrators (PDA's), Internet-enabled telephones, or any other suitable network-aware devices. Wide area network (WAN) 110 may include various gateways, hubs, routers, and other network devices, as well as one or more local area networks that are accessible to clients 202 and 212. In one embodiment, WAN 110 represents the Internet.

The depicted embodiment of system 200 includes a gateway device 120 that connects a server 220 to WAN 110. Server 220 may be implemented as a data center or server cluster that includes multiple, interconnected server systems. In such an embodiment, the server systems within server 220 may collectively represent a single universal resource indicator (URI) on system 200 such that network requests from clients 202 and 212 targeting server 220 may be processed by any of the server systems therein. In another implementation, server systems within server 220 may be logically partitioned into sub-groups where each sub-group is responsible for a step or stage in the request handling process.

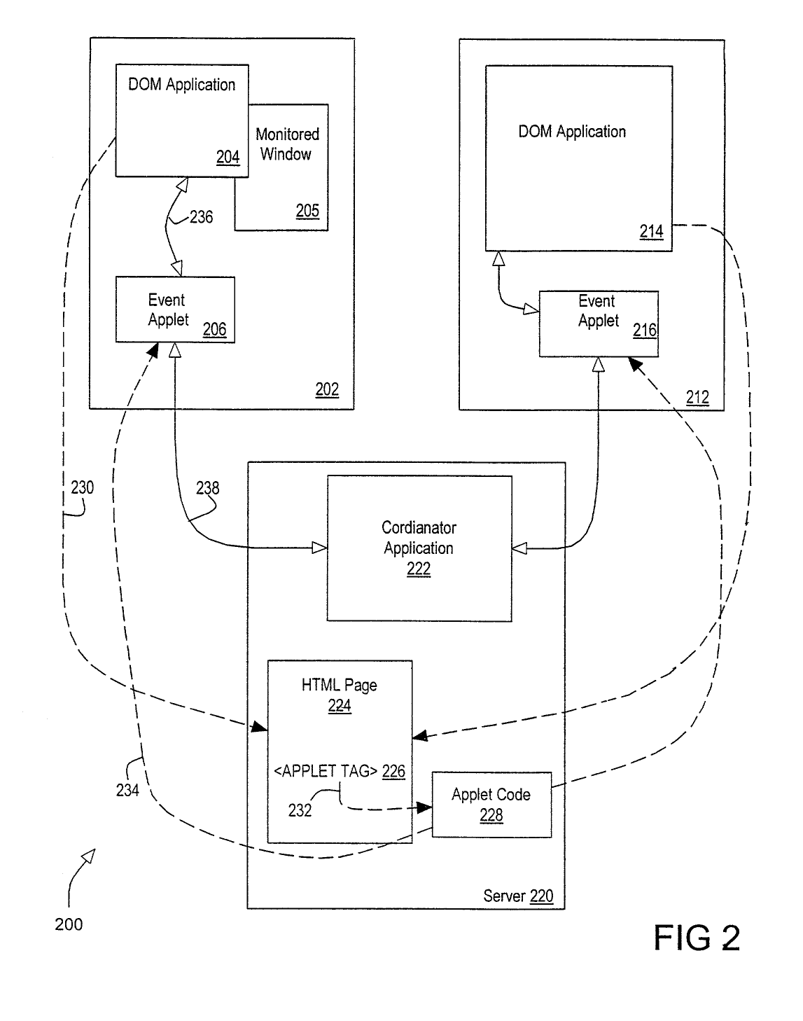

Turning now to FIG. 2, selected components of a system 200 for collaborative document manipulation according to one embodiment of the present invention are illustrated. FIG. 2 also includes a set of dashed arrows 230-234 that illustrate the manner in which the depicted state is established and a set of solid arrows 236-238 that illustrate information flow that occurs after the depicted state is established. While the numbered arrows are specific to first data processing system 202, an equivalent set of unnumbered arrows are shown for second data processing system 212. In the depicted embodiment, system 200 includes a first data processing system 202, a second data processing system 212, and a server 220. Data processing systems 202 and 212 are networked to server 220 via a suitable network connection. Systems 202 and 212 may, for example, comprise two network computers on a local area network (LAN) to which server 220 is also connected. In another example, system 202 and 212 may comprise Internet enabled devices such as desktop or laptop computers connected to server 220.

In the conceptualized depiction of FIG. 2, various software modules or components are shown to emphasize features of the present invention. It will be appreciated by those skilled in the field of data processing systems that systems 202 and 212 include additional and un-depicted components typical of data processing systems in general. More specifically, systems 202 and 212 typically include one or more general purpose microprocessors and a volatile system memory to which the processors have access for storing instructions and data. Systems 202 and 212 may further include one or more peripheral devices such as disk drive adapters, graphics adapters, network interface cards, and the like.

The elements of system 200 as depicted in FIG. 2 represent software modules that reside (at least partially) in the corresponding system's main memory. These software module elements include a first document object model (DOM) application 204 associated with first system 202, a second DOM application 214 associated with second system 212, and a server application identified as Coordinator Application 222 associated with server 220. DOM applications 204 and 214 represent user applications that implement the Document Object Model as specified by the World Wide Web consortium (www.w3c.org). The Document Object Model is an Application Programming Interface (API) for accessing and manipulating data. The DOM provides a standard for the manner in which programs may access documents and delete, add, or edit their content, attributes, and style. The DOM enables programmers to write applications that work properly on all browsers and servers and on all platforms. The DOM is a platform- and language-neutral interface that allows programming across platforms with languages such as Java® from Sun Microsystems and ECMAScript. Readers interested in additional details of the DOM are directed to the W3C DOM technical reports online at www.w3.org.

In one embodiment, each DOM application 204 and 214 represents a ubiquitous application (UA) on its corresponding system 202 and 212. For purposes of this disclosure, a UA is a piece of software characterized by a substantially universal presence on data processing systems and particularly on network-enabled data processing systems. UA's facilitate networked computing by providing functionality that extends the system's capability to document types that have achieved industry standard status. Users can typically retrieve UA's from the distributing firm or organization over the Internet free of charge. Examples of UA's include popular document viewers (e.g., Adobe Acrobat®), web browsers (e.g., Netscape and IE), and browser plug-ins (e.g., Real Player). In a typical implementation, DOM applications 204 and 214 are conventional web browsers that have implemented the DOM. Such browsers include properly configured Netscape Navigator® browsers from Netscape, Inc. and Internet Explorert browsers from Microsoft, both of which implement varying levels of the DOM.

Server 220 as shown further includes a hypertext markup language (HTML) document identified as HTML page 224. HTML is a simple data format used to create hypertext documents that are portable from one platform to another. HTML is detailed in RFC 1866 of the Internet Engineering Task Force online at www.ietf.org. The HTML page 224 of FIG. 2 preferably includes an applet tag 226 identifying the location of an applet 228.

An applet is an executable piece of code that can be included in an HTML page in much the same way as an image is included. The applet is typically written in a language such as Java®. Java® is a programming language and associated set of development tools developed by Sun Microsystems. Java® is intended for writing programs that can be executed on a variety of dissimilar computer architectures. This is accomplished by compiling Java® programs into a machine-independent byte code format, which can then be executed on any computer equipped with a Java interpreter. Java® is described in greater detail online at wwwjava.sun.com.

When a Java-enabled DOM application is used to access an HTML page that contains an applet tag, the code of the applet identified by the tag is transferred to the system memory of the computer on which the DOM application resides and executed by a Java interpreter (referred to as the Java Virtual Machine (JVM)) associated with the application. Applets are widely used to create web pages containing animation loops, arcade games, and other highly interactive applications that would be infeasible if executed from the server due to network latency and server load.

When a user of DOM application 204 (or 214) accesses (arrow 230) HTML page 224 by, for example, entering the page's universal resource locator (URL), the presence of an applet tag 226 identifying (arrow 232) applet code 228, results in applet code 228 being transferred (arrow 234) to the system memory of the corresponding system. In the depicted embodiment, the applets loaded into systems 202 and 212 when HTML page 224 is accessed are identified as event code sequences or event applets 206 and 216. These event applets are configured to monitor (arrow 236) events that occur in an open window of their corresponding DOM applications and to convey (arrow 238) those events to coordinator application 222.

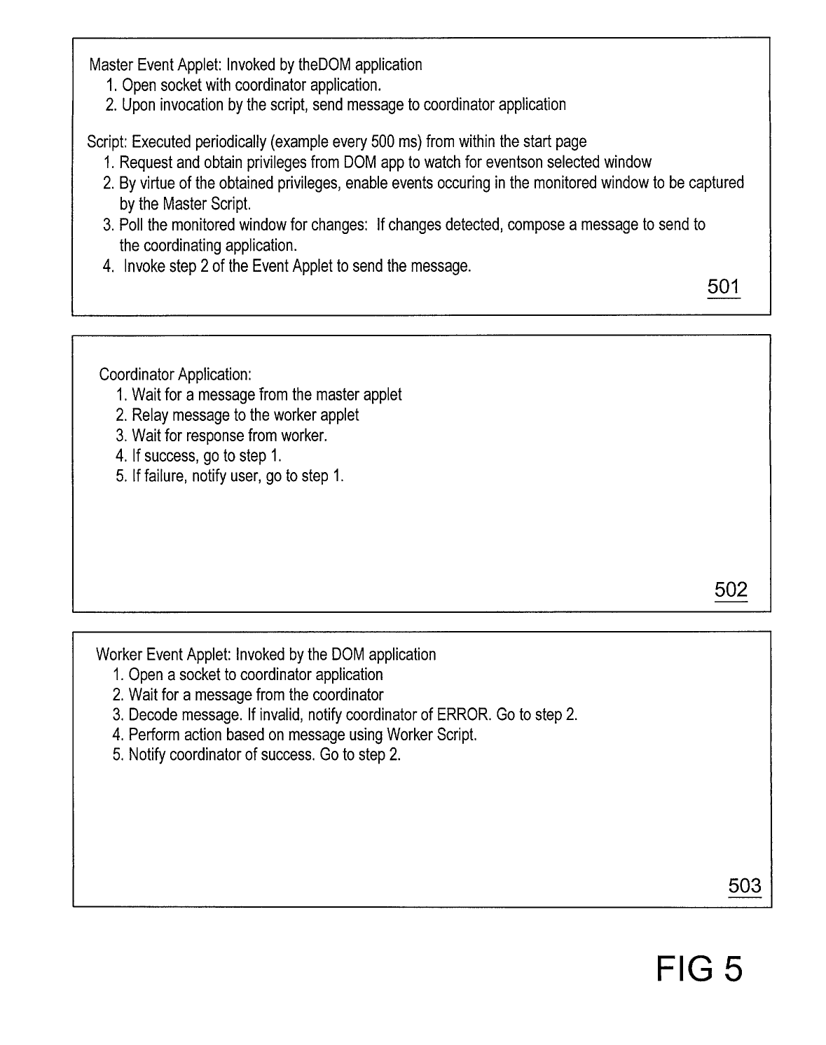

When the event applet is loaded, it opens a communication channel to coordinator application 222. Event applet 206 is associated with a script (code) that monitors for events on a selected window of DOM application 204. Typically, the script periodically (every 500 ms for example) requests and obtains privileges from DOM application 204 to monitor events (e.g., KEYPRESS, CLICK, CHANGE, SELECT) in connection with a window 205, which is typically a second window launched by DOM application 204. The script could then poll monitored window 205 for any changes including, as examples, changed URL and X and Y offsets within DOM application 204). If one or more changes are detected, the script captures the event by virtue of its privileges, and composes an event message indicating the captured event. Event applet 206 then forwards the event message to coordinator application 222. Pseudo code representative of an embodiment of server applet 206 is identified in FIG. 5 by reference numeral 501.

If a user of DOM application 204 opens a web page (after event applet 206 has been loaded), event applet 206 will recognize that a new web page has been opened and forward information indicative of the event to coordinator application 222. Similarly, if the user then enters a text string on the web page, clicks on one of the page's links, clicks on a drop down box, or performs any other action recognized through the DOM API, event applet 206 will recognize the event.

Coordinator application 222, as its name implies, enables communication between two applets that are executing on different domains. In one embodiment, coordinator application 222 performs an action loop in which it looks for updates from an event applet and, upon detecting an event from one of the applets, supplies the event to the other event applet. Pseudo code representative of coordinator application 222 is indicated in FIG. 5 by reference numeral 502.

The use of coordinator application 222 is required because of restrictions placed on applets 206 and 216. Executing applets in a secure manner is necessarily the responsibility of the DOM application. Java-enabled applications are expected to make use of Java's well defined type system in order to verify that the byte code they receive corresponds to a valid Java program. The Java language also implements an extensive application program interface (API) specification, which is the only way that applets can perform any input/output or other system functions. The application must include an implementation of the Java API class libraries, with appropriate restrictions on what applets, as untrusted code, are allowed to do.

As an example of these restrictions in the context of Java® applets embedded in HTML pages that are accessed by Java-enabled web browsers, the applets are restricted to communicate only with the server from which they were loaded. Thus, in the case where applets 206 and 216 were loaded from server 220, the applets can communicate directly only with server 220. To facilitate collaboration between users on systems 202 and 212, therefore, coordinator application 220 provides an intermediary with which both applets are permitted to communicate.

Another restriction on applets in general is that they are permitted to execute only so long as their corresponding HTML pages (the pages in which their applet tags are embedded) are open. When a browser or other DOM application releases the page containing an applet tag, execution of the corresponding applet halts. To accommodate this restriction, one embodiment of the invention contemplates that event applet 206 (and 216) will be opened in a first window of the corresponding DOM application while the monitored events occur within a second window 205. This applet window may display informative text such as “THIS WINDOW MUST REMAIN OPEN TO ENABLE COLLABORATION.” In other respects, however, the applet window is a “dummy” window that is not altered by the user after being opened. After the applet window is opened, the user opens another window in which the desired collaboration will be performed.

Although FIG. 2 illustrates an example in which there are just two event applets (206 and 216), the invention encompasses embodiments in which more than two applets are executing. In such embodiments, coordinator application 222 communicates with a group of applications. An application joins the group by loading its own copy of applet code 228.

The embodiment depicted in FIG. 2 is referred to herein as a symmetric embodiment, in which each event applet is configured to perform two primary functions. In addition to monitoring its DOM application for events as described above, each event applet is further configured to perform control actions on its application at the direction of coordinator application 222. Events detected by applet 206 (or 216), which acts as the “master applet” are delivered to coordinator application 222, which then forwards the event to the other DOM application via its applet, which acts as the “worker applet.” The worker applet receiving an event from coordinator application 222 then reproduces the event on its DOM application. Pseudo code representative of applet 216 is identified in FIG. 5 by reference numeral 503. Applet 216 may also contain code routines used to perform actions dictated by the master browser. As an example, the Javascript code for the Worker Set Selection Index script is given:

function SetFormSelectIndex (formindex, objn, objv) {

netscape.security.PrivilegeManager.enablePrivilege(“UniversalBrowserAccess”) // valid only

until exit from function

eval(′window.rcwin.document.forms[′ + formindex + ′].′ + objn + ′.selectedIndex =′ + objv
}

In the embodiment depicted in FIG. 2, event applet 206 and 216 have substantially equivalent functionality. Each is capable of communicating events to coordinator application 222 and each is capable of enacting events received from coordinator application 222. This symmetry is represented by the bidirectional arrows 236 and 238, which are intended to indicate event information flowing both to and from the corresponding DOM application.

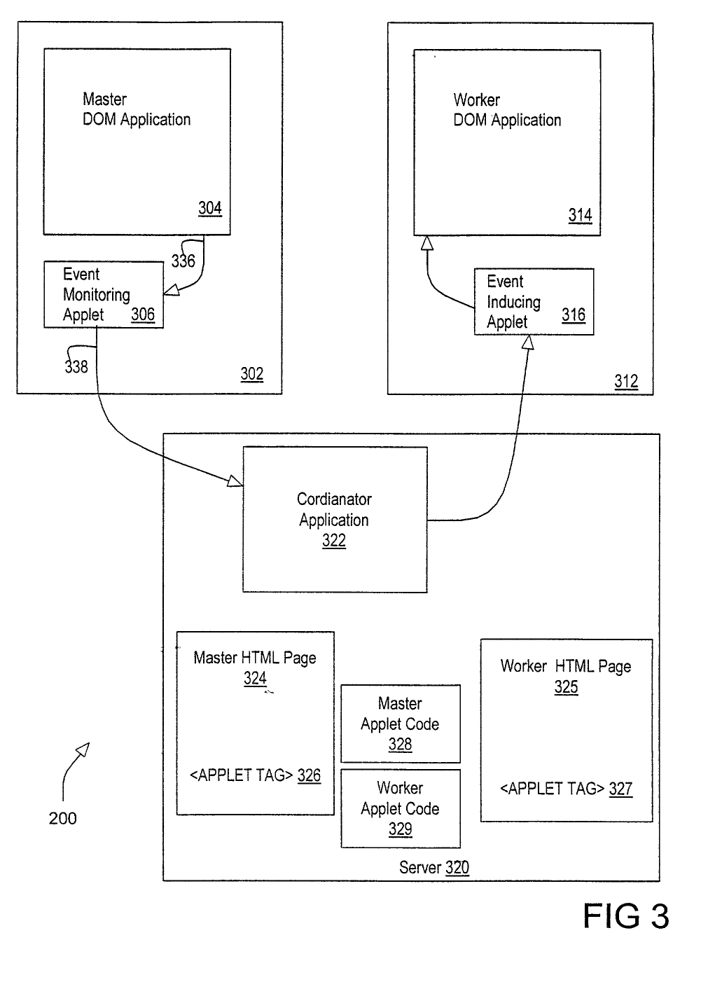

In a non-symmetric embodiment, illustrated in FIG. 3, system 220 includes a “master” DOM application 304 (on data processing system 302) that controls the collaborative events that occur, and a “worker” application 314 (on data processing system 312) that mimics the events occurring on the master. In the depicted embodiment, a server 320 includes a master HTML page 324 having a master applet tag 326 associated with a master applet 328. Server 320 further includes a worker HTML page 325 having a worker applet tag 327 associated with a worker applet 329. In this embodiment, the master DOM application 304 loads the master applet 328 by accessing the master HTML document 324, which has an applet tag 326 identifying applet 328, while worker DOM application 314 loads the worker applet 329 by accessing the worker HTML document 325, which has an applet tag 327 identifying applet 329. Master applet 328 contains the event monitoring functionality of applet 228 of FIG. 2 while worker applet 329 contains the event replication functionality of applet 228.

Thus, the master DOM application 304 is configured to transmit events to coordinator application 322 while DOM application 314 is configured to receive events from coordinator application 322. This embodiment provides a suitable implementation for environments in which it is desirable to have one of the applications effectively in control of the collaboration while the other DOM application provides a passive window into the collaborative events. Applications in which the non-symmetric implementation might be desirable include help desk or training environments in which it might be useful, for example, to have a customer service representative or the like enter information in a web page form on behalf of an uninitiated customer or trainee.

The embodiment depicted in FIG. 3 contains a potential drawback by having two different pieces of applet code to maintain. The depicted embodiment might raise security issues if unauthorized users are able to access master HTML page 324. To address these concerns, the non-symmetric embodiment of the present invention may be implemented by having coordinator application 322 designate or otherwise recognize certain of the UA's as “master UA's” while designating others as “worker UA's.” (i.e., master and worker UA's authenticate themselves to the coordinator application). In this implementation, only events that occur on a UA designated as a master UA by coordinating application 322 are duplicated on the worker UA's. This asymmetry is emphasized by the one-way arrows identified by reference numerals 336-338, which indicate the flow of event information in this embodiment.

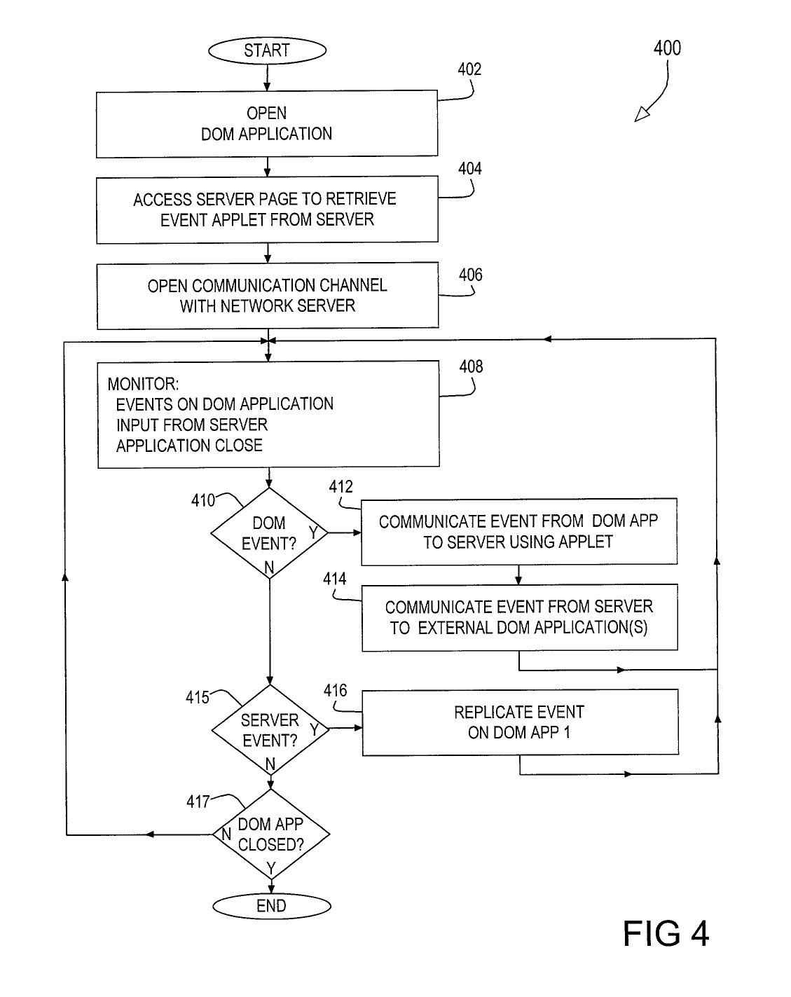

Turning now to FIG. 4, a flow diagram illustrating a method 400 for providing networked collaboration using a ubiquitous application according to one embodiment of the invention is presented. In the depicted embodiment, method 400 includes opening (block 402) a ubiquitous application (DOM application) such as a conventional web browser. The DOM application is used to access (block 404) a predetermined web page or other document located on a network server and configured to enable a user to join a collaboration group. The predetermined web page includes an applet tag that identifies applet code located on the network server. When the web page is accessed by the DOM application, the applet code is transferred to the user's system and executed by the application. The applet code opens (block 406) a communication channel with the network server.

Once transferred to the user's system, the applet monitors (block 408) for selected events. The monitored events include DOM application events such as mouse clicks and the like, server events, and an application closing event. Server events include input received from a coordinating application that resides on the network server. An application closing event occurs if the user terminates the DOM application. If a DOM application event is detected (block 410), the applet code communicates (block 412) the event to the coordinating application. The coordinating application then forwards (block 414) the event information to one or more other DOM applications (that reside on other systems and that have also joined the collaboration group by accessing a page on the network server) via their own event applets. These other DOM applications are also referred to herein as external DOM applications.

If the (local) event applet detects a server event (block 415) from the coordinating application, the applet replicates (block 416) the event on the local DOM application. In a symmetrical embodiment, the event applets on all user systems are substantially identical and are able to send event information to the network server and receive event information from the server. In other embodiments, the event applets may be segregated into master applets that communicate events to the network server and worker applets that receive event information. Finally, if the event applet determines (block 417) that the DOM application has been closed, presumably by the user, the event applet halts execution.

It will be apparent to those skilled in the art having the benefit of this disclosure that the present invention contemplates a system and method for facilitating collaborative manipulation of objects in a networked environment. It is understood that the form of the invention shown and described in the detailed description and the drawings are to be taken merely as presently preferred examples. It is intended that the following claims be interpreted broadly to embrace all the variations of the preferred embodiments disclosed.

What is claimed is:

1. A method of document collaboration in a networked data processing system, comprising:
transferring a first event code sequence from a server to a first client system responsive to a first ubiquitous application on the first client system accessing a first page on the server;
transferring a second event code sequence to a second client system responsive to a second ubiquitous application on the second client system accessing a second page on the server;
responsive to detecting a first application event by the first event code sequence, communicating information indicative of the event to the server;
forwarding information indicative of the first application event from the server to the second application; and
replicating the first application event on the second client system with the second event code sequence.

2. The method of claim 1, further comprising, disabling the event code sequences responsive to closing their respective applications.

3. The method of claim 1, wherein the first and second event code sequences are configured to communicate exclusively with the server.

4. The method of claim 1, wherein the first and second event code sequences are first and second applets.

5. The method of claim 1, wherein the first and second event code sequences have equivalent functionality wherein events occurring on the second application are replicated on the first application.

6. The method of claim 1, wherein the first and second applications are compliant with the Domain Object Model (DOM).

7. The method of claim 1, wherein the first and second applications each comprise a web browser.

8. The method of claim 1, wherein the server includes a coordinating application configured to receive the event information from the first event code sequence and further configured to forward the event information to the second application.

9. A data processing network, comprising:
a server including a first event code sequence, the server configured to transfer the first code sequence to a first client system responsive to a first ubiquitous application on the first client system accessing a first page on the server;
server means for transferring a second event code sequence to a second client system responsive to a second ubiquitous application on the second client system accessing a second page on the server;
first client code means for communicating information indicative of a first application event to the server responsive to detection of the first application event by the first event code sequence;
server code means for forwarding information indicative of the first application event from the server to the second application; and
second client code means for replicating the first application event on the second client system with the second event code sequence.

10. The network of claim 9, further comprising, disabling the event code sequences responsive to closing their respective applications.

11. The network of claim 9, wherein the first and second event code sequences are configured to communicate exclusively with the server.

12. The network of claim 9, wherein the first and second event code sequences are first and second applets.

13. The network of claim 9, wherein the first and second event code sequences have equivalent functionality wherein events occurring on the second application are replicated on the first application.

14. The network of claim 9, wherein the first and second applications are compliant with the Domain Object Model (DOM).

15. The network of claim 9, wherein the first and second applications each comprise a web browser.

16. The network of claim 9, wherein the server includes a coordinating application configured to receive the event information from the first event code sequence and further configured to forward the event information to the second application.

17. A network server, comprising:
server code means for transferring a first event code sequence to a first client system responsive to a first ubiquitous application on the first client system accessing a first page on the server;
server code means for transferring a second event code sequence to a second client system responsive to a second ubiquitous application on the second client system accessing a second page on the server;
server code means for receiving information indicative of a first application event from the first client responsive to detecting of a first application event by the first event code sequence; and
server code means for forwarding information indicative of the first application event from the server to the second application.

18. The server of claim 17, wherein the first and second event code sequences are configured to communicate exclusively with the server.

19. The server of claim 17, wherein the first and second event code sequences are first and second applets.

20. The server of claim 17, wherein the first and second event code sequences have equivalent functionality wherein events occurring on the second application are replicated on the first application.

21. The server of claim 17, wherein the server includes a coordinating application configured to receive the event information from the first event code sequence and further configured to forward the event information to the second application.
